(19) United States
(12) Patent Application Publication
(10) Pub. No.: US 2019/0112474 A1
(43) Pub. Date: Apr. 18, 2019

(54) POROUS THERMOPLASTIC MEMBRANES

(71) Applicant: BASF SE, Ludwigshafen am Rhein (DE)

(72) Inventors: Oliver GRONWALD, Ludwigshafen (DE); Martin WEBER, Ludwigshafen (DE); Juergen AHLERS, Ludwigshafen (DE); Frank PRISSOK, Lemfoerde (DE)

(73) Assignee: BASF SE, Ludwigshafen am Rhein (DE)

(21) Appl. No.: 16/090,663

(22) PCT Filed: Apr. 11, 2017
(86) PCT No.: PCT/EP2017/058665

§ 371 Date: Oct. 2, 2018

(30) Foreign Application Priority Data
Apr. 11, 2016 (EP) 16164661.7

(51) Int. Cl. C08L 75/04; C08G 18/76; C08G 18/73; C08G 18/32; C08G 18/61; C08G 18/65; C08J 5/18; D06M 15/564; B01D 71/54; B01D 67/00; B01D 69/02

(52) U.S. Cl. CPC C08L 75/04; B01D 2325/02; C08G 18/7614; C08G 18/73; C08G 18/3206; C08G 18/61; C08G 18/6511; C08J 5/18; D06M 15/564; B01D 71/54; B01D 67/0013; B01D 69/02; C08L 2205/025; C08J 2375/04; C08J 2475/04; C08G 18/7671

(57) ABSTRACT

The present invention is directed to a membrane, comprising a polyurethane (PU1), wherein the polyurethane (PU1) is based on 80 to 100% by weight of a mixture of at least one diol (D1) and at least one polyisocyanate (I1), and 0 to 20% by weight of at least one compound (C1) with at least two functional groups which are reactive towards isocyanate groups. Furthermore, the present invention is directed to a process for preparing a membrane, comprising providing a solution (L1) at least comprising a polyurethane (PU1) and preparing a membrane from solution (L1) using phase inversion; as well as the use of a membrane according to the present invention for coating a woven article.

The present invention relates to a membrane, comprising a polyurethane (PU1), wherein the polyurethane (PU1) is based on 80 to 100% by weight of a mixture of at least one diol (D1) and at least one polyisocyanate (I1), and 0 to 20% by weight of at least one compound (C1) with at least two functional groups which are reactive towards isocyanate groups. Furthermore, the present invention is directed to a process for preparing a membrane, comprising providing a solution (L1) at least comprising a polyurethane (PU1) and preparing a membrane from solution (L1) using phase inversion; as well as the use of a membrane according to the present invention for coating a woven article.

Membranes for different purposes are known from the state of the art. Membranes are in particular used for separation purposes. For many applications, high water resistance is needed in combination with vapor permeability.

Membranes formed by phase inversion of polymer solutions are widely used in water filtration. According to the state of the art, a membrane may for example be produced by subjecting a backing fabric to phase inversion by casting a polymer solution onto the fabric to produce a coated fabric, introducing the coated fabric to a coagulation bath, and thereafter subjecting the coated fabric to annealing.

For the preparation of thin, semi-permeable membranes dry and wet manufacturing processes are currently used. Expanded PTFE (ePTFE) membranes are being prepared by an extrusion process of highly crystalline PTFE pellets with subsequent uni- or bidirectional stretching. As result, the process produces micro-porous membranes with nodes interconnected by small fibrils.

U.S. Pat. No. 4,194,041 relates to a waterproof article for use in, for example, protective clothing. The article prevents liquid water from penetrating through to undergarments while at the same time permitting moisture vapor such as perspiration to pass out through the article. The article is thus both breathable and waterproof.

However, due to environmental reasons the replacement of ePTFE membranes with non-halogenated substitutes is under investigation. Thus, as alternative TPU membranes are being manufactured by the means of a wet process comprising the coagulation of polymer solutions with inorganic fillers as pore former. These porous layers are very thick (>0.5 mm) or have to be manufactured directly on textile layers as support material.

It was therefore an object of the invention to avoid the abovementioned disadvantages. In particular, it was an object to develop a material and process for mechanically stable, semi-permeable, non-halogenated porous films.

According to the present invention, this object is solved by a membrane, comprising a polyurethane (PU1), wherein the polyurethane (PU1) is based on the following components:
80 to 100% by weight of a mixture of at least one diol (D1) and at least one polyisocyanate (I1), and
0 to 20% by weight of at least one compound (C1) with at least two functional groups which are reactive towards isocyanate groups.

In the context of the present invention, the amount of the components of which the polyurethane is based adds up to 100% by weight. These components form the polymeric structure of the polyurethane. Additionally, the polyurethane may comprise further additives.

In the context of this application a membrane shall be understood to be a thin, semipermeable structure capable of separating two fluids or separating molecular and/or ionic components or particles from a liquid. A membrane acts as a selective barrier, allowing some particles, substances or chemicals to pass through, while retaining others.

For example, membranes can be reverse osmosis (RO) membranes, forward osmosis (FO) membranes, nanofiltration (NF) membranes, ultrafiltration (UF) membranes or microfiltration (MF) membranes.

The membrane according to the present invention has pores with an average pore diameter in the range of from 0.001 μm to 0.8 μm, determined using Hg porosimetry according to DIN 66133.

Therefore, according to the present invention, the object of the present invention as described above is in particular solved by a membrane, comprising a polyurethane (PU1), wherein the polyurethane (PU1) is based on the following components:
80 to 100% by weight of a mixture of at least one diol (D1) and at least one polyisocyanate (I1), and
0 to 20% by weight of at least one compound (C1) with at least two functional groups which are reactive towards isocyanate groups.

wherein the membrane has pores with an average pore diameter in the range of from 0.001 μm to 0.8 μm, determined using Hg porosimetry according to DIN 66133.

It has been surprisingly found that membranes with the defines pore structure with an average pore diameter in the range of from 0.001 μm to 0.8 μm, determined using Hg porosimetry according to DIN 66133 are particularly advantageous. According to a further embodiment, the average pore diameter is in the range of from 0.002 μm to 0.5 μm, determined using Hg porosimetry according to DIN 66133.

The pore size distribution within the membranes according to the present invention preferably is not homogenous but the membrane comprises pores with different pore sizes. Preferably, the pore size distribution has a gradient over the diameter of the membrane. A gradient over the diameter of the membrane in the context of the present invention is to be understood in the way that the pores on one surface of the membrane or close to said surface have an average pore diameter which is different from the average pore diameter of the second surface or close to said second surface of the membrane.

Therefore, according to a further embodiment, the present invention is directed to a membrane as disclosed above, wherein the pore size distribution has a gradient over the diameter of the membrane.

In the context of the present invention, it is for example possible that the pores on or close to one surface have an average pore diameter in the range of from 0.001 μm to 0.01 μm, determined using Hg porosimetry according to DIN 66133, and the pores on or close to the second surface have an average pore diameter in the range of from 0.1 μm to 0.8 μm, determined using Hg porosimetry according to DIN 66133. The degree of the gradient of the pore diameter within the membrane can vary in wide ranges according to the present invention. The relation of the pore diameter of the pores on or close to one surface of the membrane to the pores on or close to the second surface have an average pore diameter can for example be in the range of from 1:5 to 1:10000, preferable in the range of from 1:10 to 1:1000. More preferable in the range of from 1:100 to 1:500.

Preferred embodiments may be found in the claims and the description. Combinations of preferred embodiments do not go outside the scope of the present invention. Preferred embodiments of the components used are described below.

According to the present invention, it has been found that stable membranes can be prepared from polyurethanes based on 80 to 100% by weight of a mixture of at least one diol (D1) and at least one polyisocyanate (I1), and 0 to 20% by weight of at least one compound (C1) with at least two functional groups which are reactive towards isocyanate groups. The polyurethanes used for the preparation of the membranes according to the present invention therefore only comprise none or a small portion of compound (C1) and mainly consists of a mixture of diol (D1) and polyisocyanate (I1). Preferably, polyurethane (PU1) is based on 85 to 100% by weight of a mixture of at least one diol (D1) and at least one polyisocyanate (I1), and 0 to 15% by weight of at least one compound (C1) with at least two functional groups which are reactive towards isocyanate groups, more preferable 90 to 99.9% by weight of a mixture of at least one diol (D1) and at least one polyisocyanate (I1), and 0.1 to 10% by weight of at least one compound (C1) with at least two functional groups which are reactive towards isocyanate groups.

The molar ratio of the at least one diol (D1) and the alt least one polyisocyanate generally is in the range of from 95:100 to 100:95 according to the present invention. Preferably, the molar ratio of the at least one diol (D1) and the alt least one polyisocyanate generally is in the range of from 98:100 to 100:98, more preferable in the range of from 99:100 to 100:99.

According to the present invention, the membrane may also comprise further compounds such as a further polyurethane. The membrane may for example comprise a further polyurethane (PU2) which may be a thermoplastic polyurethane.

Thus, according to a further embodiment, the present invention is also directed to a membrane as disclosed above, wherein the membrane comprises a further polyurethane (PU2) which is based on at least one polyol (P2), at least one diol (D2) and at least one polyisocyanate (I2).

Generally, the membrane comprises at least 80 wt % of polyurethane (PU1), preferably at least 85 wt % of polyurethane (PU1), more preferable at least 90 wt % of polyurethane (PU1). The membrane may for example comprise polyurethane (PU1) in an amount in the range of from 80 to 100 wt %, more preferable in the range of from 85 to 99 wt %, in particular in the range of from 90 to 95 wt %.

Polyurethane (PU1) is based on 80 to 100% by weight of a mixture of at least one diol (D1) and at least one polyisocyanate (I1), and 0 to 20% by weight of at least one compound (C1) with at least two functional groups which are reactive towards isocyanate groups.

Compound (C1) may be any compound with at least two functional groups which are reactive towards isocyanate groups. Preferably, the functional groups which are reactive towards isocyanate groups are hydroxyl or amino groups. Compound (C1) may be added to modify the properties of the polyurethane (PU1). Any compound can be used as long as it can be used to form a polyurethane (PU1) with the mixture of at least one diol (D1) and at least one polyisocyanate (I1). For example, compound (C1) may be a polyol but compound (C1) may also be a polymer with at least two hydroxyl groups or at least two amino groups other than a polyol, for example a hydrophobic polymer or oligomer comprising silicon.

Suitable are for example oligo- or polysiloxanes, preferably oligo- or polysiloxanes of the formula

-[Ak-O]_{q}-Ak-Si(R₂)-[O—Si(R₂)]ₚ—O—Si(R₂)-Ak-[O-Ak]_{q′}- (I)

wherein Ak represents C₂-C₄ alkylene, R represents C₁-C₄ alkyl, and each of p, q and q′ independently is a number selected from the range of 0 to 50. In more preferred moieties (B) of formula (I), p ranges from 1 to 50, especially from 2 to 50.

Ak may represent identical alkylene units in each residue (C1), but Ak may also represent different alkylene units in the same residue (C1). Ak can for example be ethylene or propylene within the same residue (C1).

Suitable are for example a polydimethylsiloxane of formula (II)

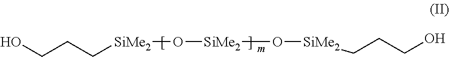

with m in the range from 5 to 80, or a polydimethylsiloxane of formula (III)

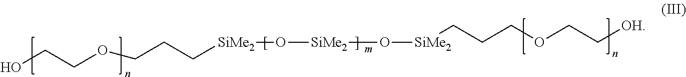

According to a further embodiment, the present invention is also directed to a membrane as disclosed above, wherein the compound (C1) is selected from the group of divalent residues of an oligo- or polysiloxane of the formula

-[Ak-O]_{q}-Ak-Si(R₂)—[O—Si(R₂)]ₚ—O—Si(R₂)-Ak-[O-Ak]_{q′}- (I)

wherein Ak represents C₂-C₄alkylene, R represents C₁-C₄ alkyl, and each of p, q and q′ independently is a number selected from the range of 0 to50. In more preferred moieties (B) of formula (I), p ranges from 1 to 50, especially from 2 to 50.

In one embodiment, Ak represents identical alkylene units in each residue (C1). In one embodiment, Ak may represent different alkylene units in the same residue (C1). For example, Ak can be ethylene or propylene within the same residue (C1).

In one embodiment (C1) is represented by polydimethylsiloxane of formula (II)

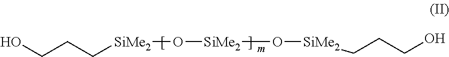

with m in the range from 5 to 80,

in another embodiment (C1) is a polydimethylsiloxane of formula (III)

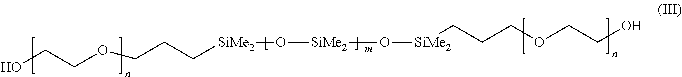

wherein n and m are in the range from 5 to 80.

According to another embodiment, the present invention is also directed to a membrane as disclosed above, wherein the compound (C1) is a polyol.

For the purposes of the present invention it is possible here to use any suitable polyol as compound (C1), for example polyether diols or polyester diols, or a mixture of two or more thereof.

Suitable polyether polyols or diols according to the present invention are for example polyether diols based on ethylene oxide or propylene oxide or mixtures thereof, for example copolymers such as blockcopolymers. Furthermore, the invention can use any suitable polyester diols, and for the purposes of the present invention the expression polyester diol also comprises polycarbonate diols.

The composition and the properties of the membrane can be varied depending on the application.

For example the thickness of the membrane can be varied in a wide range. Preferably the membrane has a thickness in the range from 5 to 100 μm, more preferably in the range from 20 to 80 μm, in particular in the range from 30 to 60 μm.

Thus, according to a further embodiment, the present invention is also directed to a membrane as disclosed above, wherein the membrane has a thickness in the range from 5 to 100 μm.

The membranes according to the present invention show high liquid entry pressures (LEP, measured according to DIN EN 20811) and good water vapor permeability values (WDD, measured according to DIN 53122). According to the present invention, the membranes have a liquid entry pressure in the range of 1 to 5 bar, preferably 3 to 4 bar.

Thus, according to a further embodiment, the present invention is also directed to a membrane as disclosed above, wherein the membrane has a liquid entry pressure in the range of 1 to 5 bar.

According to the present invention, polyurethane (PU1) is based on 80 to 100% by weight of a mixture of at least one diol (D1) and at least one polyisocyanate (I1). Polyurethane (PU2) which may also be present in the membrane according to one embodiment of the present invention is based on at least one polyol (P2), at least one diol (D2) and at least one polyisocyanate (I2).

Polyisocyanate (I1) and polyisocyanate (I2) may be the same or different according to the present invention. As polyisocyanates it is possible to use aliphatic, cycloaliphatic, araliphatic and/or aromatic diisocyanates. Specific examples include the following aromatic isocyanates: 2,4-toluene diisocyanate, mixtures of 2,4- and 2,6-toluene diisocyanate, 4,4′-, 2,4′- and/or 2,2′-diphenylmethane diisocyanate (MDI), mixtures of 2,4′- and 4,4′-diphenylmethane diisocyanate, urethane-modified liquid 4,4′- and/or 2,4-diphenylmethane diisocyanates, 4,4′-diisocyanatodiphenylethane, the mixtures of monomeric methanediphenyl diisocyanates and more highly polycyclic homologues of methanediphenyl diisocyanate (polymeric MDI), 1,2- and 1,5-naphthylene diisocyanate.

Aliphatic diisocyanates used are customarily aliphatic and/or cycloaliphatic diisocyanates, examples being tri-, tetra-, penta-, hexa-, hepta- and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), 1,4-cyclohexane diisocyanate, 1-methyl-2,4- and/or -2,6-cyclohexane diisocyanate, 4,4′-, 2,4′- and/or 2,2′-dicyclohexylmethane diisocyanate.

Polyisocyanate prepolymers are obtainable by reacting above-described polyisocyanates in excess, at temperatures of 30 to 100° C., for example, preferably at about 80° C., with polyols to give the prepolymer. For the preparation of the prepolymers of the invention, preference is given to using polyisocyanates and commercial polyols based on polyesters, starting for example from adipic acid, or on polyethers, starting for example from ethylene oxide and/or propylene oxide.

Polyols are known to the skilled person and are described for example in “Kunststoffhandbuch, volume 7, Polyurethane”, Carl Hanser Verlag, 3rd edition 1993, section 3.1. Polyols used with preference in this context are the polymeric compounds described under b), having hydrogen atoms that are reactive toward isocyanates. Particularly preferred for use as polyols are polyetherols.

In the preparation of the isocyanate prepolymers, customary chain extenders or crosslinking agents are added optionally to the stated polyols. Such substances are described under c) hereinafter. Particularly preferred for use as chain extender is 1,4-butanediol, dipropylene glycol and/or tripropylene glycol. In this case the ratio of organic polyisocyanates to polyols and chain extenders is preferably selected such that the isocyanate prepolymer has an NCO content of 2% to 30%, preferably of 6% to 28%, more preferably of 10% to 24%.

Particularly preferred polyisocyanates are selected from the group consisting of MDI, polymeric MDI, and TDI, and also derivatives thereof or prepolymers of these polyisocyanates.

In a further embodiment, accordingly, the at least one polyisocyanate preferably is selected from the group consisting of aromatic, araliphatic, and aliphatic polyisocyanates.

In accordance with the invention, the polyisocyanate can be used in pure form or in the form of a composition, for example, an isocyanate prepolymer. In a further embodiment, a mixture can be used which comprises polyisocyanate and at least one solvent. Suitable solvents are known to the skilled person.

Thus, according to a further embodiment, the present invention is also directed to a membrane as disclosed above, wherein the polyisocyanate is selected from the group consisting of diphenylmethanediisocyanate (MDI), toluenediisocyanate (TDI) and hexamethylenediisocyanate (HDI).

According to the present invention, diol (D1) and diol (D2) may be the same or different. Generally, any diol can be used in the context of the present invention. Diol (D1) and diol (D2) can preferably be selected from aliphatic, araliphatic, aromatic, and/or cycloaliphatic compounds with a molar mass of from 0.05 kg/mol to 0.499 kg/mol, preferably difunctional compounds, for example diamines and/or alkanediols having from 2 to 10 carbon atoms in the alkylene moiety, di-, tri-, tetra-, penta-, hexa-, hepta-, octa-, nona-, and/or decaalkylene glycols having from 3 to 8 carbon atoms, in particular ethylene 1,2-glycol, 1,3-propanediol, 1,4-butanediol, 1,6-hexanediol, and preferably corresponding oligo- and/or polypropylene glycols such as diethylene glycol, dipropylene glycol, 1,4-cyclohexanediol, 1,4-dimethanolcyclohexane, and neopentyl glycol, and it is also possible here to use a mixture of the chain extenders. It is preferable that the diols used have only primary hydroxy groups, and very particular preference is given to ethane diol, butane diol and hexane diol.

Thus, according to a further embodiment, the present invention is also directed to a membrane as disclosed above, wherein the diol (D1) is selected from the group consisting of ethane diol, butane diol and hexane diol.

According to the present invention, the polyurethane (PU1) and/or polyurethane (PU2) may be prepared using further components such as for example catalysts, and/or conventional auxiliaries and/or of additives.

Conventional auxiliaries may be for example surfactant substances, fillers, further flame retardants, nucleating agents, oxidation stabilizers, lubricants and mold-release aids, dyes, and pigments, and optionally stabilizers, e.g. for protection from hydrolysis, light, heat, or discoloration, inorganic and/or organic fillers, reinforcing agents, and plasticizers. Suitable auxiliaries and additives can be found by way of example in Kunststoffhandbuch [Plastics handbook], volume VII, edited by Vieweg and Hochtlen, Carl Hanser Verlag, Munich 1966 (pp. 103-113).

For the preparation of polyurethane (PU2) a polyol (P2) is used as a further component. Polyol (P2) preferably is a diol. For the purposes of the present invention it is possible here to use any of the suitable diols, for example polyether diols or polyester diols, or a mixture of two or more thereof.

Suitable polyether diols according to the present invention are for example polyether diols based on ethylene oxide or propylene oxide or mixtures thereof, for example copolymers such as blockcopolymers. The ratio of ethylene oxide units to propylene oxide units can vary in wide ranges, the ratio of ethylene oxide units to propylene oxide units can for example be in the range of from 50:50 to 95:5, preferably in the range of from 60:40 to 90:10, more preferred in the range of from 70:30 to 85:15, in particular preferred in the range of from 75:25 to 80:20. The molecular weight of the polyether diols used in the present invention is for example in the range of from 1000 to 4000 Dalton, preferably in the range of from 1500 to 3000 Dalton, more preferred in the range of from 2000 to 2500 Dalton.

Furthermore, the invention can use any suitable polyester diols, and for the purposes of the present invention the expression polyester diol also comprises polycarbonate diols.

Suitable polyester diols can by way of example be produced from organic dicarboxylic acids having from 2 to 12 carbon atoms, preferably aromatic dicarboxylic acids having from 8 to 12 carbon atoms, and from polyhydric alcohols, preferably diols, having from 2 to 12 carbon atoms, preferably from 2 to 6 carbon atoms. Examples of dicarboxylic acids that can be used are: succinic acid, glutaric acid, adipic acid, suberic acid, azelaic acid, sebaic acid, decanedicarboxylic acid, maleic acid, fumaric acid, and phthalic acid, isophthalic acid, terephthalic acid, and the isomeric naphthalenedicarboxylic acids. The dicarboxylic acids can be used either individually or else in a mixture with one another. Instead of the free dicarboxylic acids it is also possible to use the corresponding dicarboxylic acid derivatives, for example dicarboxylic esters of alcohols having from 1 to 4 carbon atoms, or dicarboxylic anhydrides. Examples of di- and polyhydric alcohols, in particular diols, are ethanediol, diethylene glycol, 1,2- and 1,3-propanediol, dipropylene glycol, 1,4-butanediol, 1,5-pentanediol, 1,6-hexanediol, 1,10-decanediol, glycerol, and trimethylolpropane, preferably ethylene glycol, 1,3-propanediol, methyl-1,3-propanediol, 1,4-butanediol, 3-methyl-1,5-pentanediol, or 1,6-hexanediol. Examples of other compounds suitable in the invention are polyester diols made of lactones, such as c-caprolactone, or hydroxycarboxylic acids, e.g. ω-hydroxycaproic acid and hydroxybenzoic acids.

It has been found according to the present invention that when using at least one polyurethane (PU1) as disclosed above, stable films or membranes can be prepared from a suitable solution of the polyurethane (PU1) using phase inversion.

Thus, according to a further aspect, the present invention is also directed to a process for preparing a membrane, comprising the steps
(i) providing a solution (L1) at least comprising a polyurethane (PU1);
(ii) preparing a membrane from solution (L1) using phase inversion.

According to a further embodiment, the present invention is also directed to a process, wherein the membrane has pores with an average pore diameter in the range of from 0.001 μm to 0.8 μm, determined using Hg porosimetry according to DIN 66133.

According to a further embodiment, the present invention is also directed to a process for preparing a membrane as disclosed above, wherein the pore size distribution has a gradient over the diameter of the membrane.

According to step (i), a solution (L1) at least comprising a polyurethane (PU1) is provided. The solution (L1) comprises polyurethane (PU1) and at least one suitable solvent or a solvent mixture. Suitable solvents are for example selected from the group consisting of organic, especially aprotic polar solvents. Suitable solvents also have a boiling point in the range from 80 to 320° C., especially 100 to 280° C., preferably from 150 to 250° C. Suitable aprotic polar solvents are, for example, high-boiling ethers, esters, ketones, asymmetrically halogenated hydrocarbons, anisole, N,N-dimethylformamide, N,N-dimethylacetamide, dimethyl sulfoxide, sulfolane, N,N-dimethyl-2-hydroxypropanoic amide, N,N-diethyl-2-hydroxypropanoic amide, N,N-dimethyl-2-methoxypropanoic amide, N,N-diethyl-2-methoxypropanoic amide, N-formyl-pyrrolidine, N-acetyl-pyrrolidine, N-formylpiperidine, N-acetylpiperidine, N-formyl-morpholine, N-acetyl-morpholine, N-methyl-2-pyrrolidone and/or N-ethyl-2-pyrrolidone. It is also possible to use mixtures of these solvents.

Particularly preferred is N-methylpyrrolidone as solvent for solution (L1) in the context of the present invention. Solution (L1) may comprise polyurethane (PU1) in an amount sufficient to form a film from the solution. Solution (L1) comprises for example 10 to 35 wt % of polyurethane (PU1), preferably 15 to 25 wt %.

The solution (L1) may be prepared at elevated temperature according to the present invention.

According to step (ii), a membrane is prepared from solution (L1) using phase inversion. Suitable methods are in principle known to the person skilled in the art. According to the present invention, preferably non-solvent induced phase inversion is carried out. Step (ii) may for example comprise the steps (ii-a) and (ii-b):
(ii-a) forming a film from solution (L1);
(ii-b) bringing the film in contact with a mixture (L2).

According to step (ii-a), a film is formed from solution (L1) using methods generally known to the person skilled in the art. The film is then brought in in contact with a mixture (L2) according to step (ii-b). Step (ii) causes coagulation and membranes are obtained. Mixture (L2) may comprise any compound which is suitable to cause coagulation. Mixture (L2) has a lower solubility of polyurethane (PU1) than the solvent used for the preparation of (L1). In particular, nonsolvents are used such as for example water or mixtures comprising water. Suitable coagulants comprise for example liquid water, water vapor, alcohols or mixtures thereof. In one embodiment coagulants (L2) are liquid water, water vapor, alcohols or mixtures thereof. Preferably alcohols suitable as coagulants (L2) are mono-, di- or trialkanols bearing no further functional groups like iso-propanol, ethylene glycol or propylene glycol.

According to the present invention, step (ii), in particular steps (ii-a) and/or (ii-b) may also be carried out at elevated temperature.

Thus, according to a further embodiment, the present invention is also directed to a process for preparing a membrane, comprising the steps
(i) providing a solution (L1) at least comprising a polyurethane (PU1);
(ii) preparing a membrane from solution (L1) using phase inversion, step (ii) comprising the steps (ii-a) and (ii-b):
(ii-a) forming a film from solution (L1);
(ii-b) bringing the film in contact with a mixture (L2).

Solution (L1) comprises at least polyurethane (PU1) but may comprise further compounds or additives. According to one embodiment of the present invention, solution (L1) further comprises polyurethane (PU2). Solution (L1) may also comprise additives such as polyhydroxy compounds such as diols or triols. For example additives selected from the group of mono-, di- or trialkanols bearing no further functional groups like iso-propanol, ethylene glycol, propylene glycol or propylenetriol (glycerin) may be used.

Preferably, glycerin is used as additive in solution (L1) according to the present invention.

Thus, according to a further embodiment, the present invention is also directed to a process as disclosed above, wherein the solution (L1) comprises at least one additive selected from the group consisting of mono-, di- or trialkanols bearing no further functional groups like isopropanol, ethylene glycol, propylene glycol or propylenetriol (glycerin)

Thus, according to a further embodiment, the present invention is also directed to a process as disclosed above, wherein step (ii) comprises the steps (ii-a) and (ii-b):
(ii-a) forming a film from solution (L1);
(ii-b) bringing the film in contact with a mixture (L2).

Thus, according to a further embodiment, the present invention is also directed to a process as disclosed above, wherein the mixture (L2) comprises water.

According to the process of the present invention, a film is obtained which can be used as a membrane. The process of the present invention can also comprise further steps, for example washing steps or a temperature treatment.

The film or membrane obtained or obtainable according to the process of the present invention is stable and has advantageous properties such as high liquid entry pressures (LEP, measured according to DIN EN 20811) and good water vapor permeability values (WDD, according to DIN 53122). Thus, the membranes according to the present invention are particularly suitable for applications which require a high permeability for vapor such as in functional wear.

As described above, the membrane obtained or obtainable according to the process of the present invention has pores with an average pore diameter in the range of from 0.001 μm to 0.8 μm, determined using Hg porosimetry according to DIN 66133.

According to a further embodiment, the average pore diameter is in the range of from 0.002 μm to 0.5 μm, determined using Hg porosimetry according to DIN 66133.

The pore size distribution within the membranes obtained or obtainable according to the process of the present invention preferably is not homogenous but the membrane comprises pores with different pore sizes. Preferably, the pore size distribution has a gradient over the diameter of the membrane.

In the context of the present invention, it is for example possible that the pores on or close to one surface have an average pore diameter in the range of from 0.001 μm to 0.01 μm, determined using Hg porosimetry according to DIN 66133, and the pores on or close to the second surface have an average pore diameter in the range of from 0.1 μm to 0.8 μm, determined using Hg porosimetry according to DIN 66133. The degree of the gradient of the pore diameter within the membrane can vary in wide ranges according to the present invention. The relation of the pore diameter of the pores on or close to one surface of the membrane to the pores on or close to the second surface have an average pore diameter can for example be in the range of from 1:5 to 1:10000, preferable in the range of from 1:10 to 1:1000, more preferable in the range of from 1:100 to 1:500.

The membranes according to the present invention can be used as such or for example as a coating layer for a woven article.

According to a further aspect, the present invention is also directed to the use of a membrane as disclosed above or a membrane obtained or obtainable according to a process as disclosed above for coating a woven article.

The membranes according to the present invention can be used for example in outerwear, sportswear for example for sailing, hiking or skiing, rainwear, protective wear such as trousers, jackets, shoes, gloves, hats, caps. Furthermore, the membranes according to the present invention can be used for example in protective covers, for tents, backpacks, umbrellas or for example in applications for automotives such as covers and tops for convertibles.

Further embodiments of the present invention are apparent from the claims and the examples. It is understood that the features of the subject matter/method/uses of the invention, as elucidated below and as stated above, can be used not only in the particular combination specified but also in other combinations as well, without departing the scope of the invention. Accordingly, for example, the combination of a preferred feature with a more preferred feature, or of an otherwise uncharacterized feature with a very preferred feature, etc., is implicitly comprised, even if that combination is not expressly mentioned.

Listed below are exemplary embodiments of the present invention, which do not restrict the present invention. In particular, the present invention also encompasses embodiments which arise from the dependency references stated below, and hence combinations.

The present invention includes the following embodiments, wherein these include the specific combinations of embodiments as indicated by the respective interdependencies defined therein.
1. Membrane, comprising a polyurethane (PU1), wherein the polyurethane (PU1) is based on the following components:
   80 to 100% by weight of a mixture of at least one diol (D1) and at least one polyisocyanate (I1), and
   0 to 20% by weight of at least one compound (C1) with at least two functional groups which are reactive towards isocyanate groups.
2. The membrane according to embodiment 1, wherein the membrane comprises a further polyurethane (PU2) which is based on at least one polyol (P2), at least one diol (D2) and at least one polyisocyanate (I2).
3. The membrane according to any of embodiments 1 or 2 wherein the compound (C1) is a polyol.
4. The membrane according to any one of embodiments 1 to 3 wherein the compound (C1) is selected from the group of divalent residues of an oligo- or polysiloxane of the formula

-[Ak-O]_{q}-Ak-Si(R₂)—[O—Si(R₂)]ₚ—O—Si(R₂)-Ak-[O-Ak]_{q′}- (I)
wherein Ak represents C₂-C₄ alkylene, R represents C₁-C₄ alkyl, and each of p, q and q′ independently is a number selected from the range 0-50. In more preferred moieties of formula (I), p ranges from 1 to 50, especially from 2 to 50.
5. The membrane according to any one of embodiments 1 to 4 wherein the membrane has a thickness in the range from 5 to 100 μm.
6. The membrane according to any one of embodiments 1 to 5 wherein the membrane has a liquid entry pressure in the range of 1 to 5 bar.
7. The membrane according to any one of embodiments 1 to 6 wherein the diol (D1) is selected from the group consisting of ethane diol, butane diol and hexane diol.
8. The membrane according to any one of embodiments 1 to 7 wherein the polyisocyanate is selected from the group consisting of diphenylmethanediisocyanate (MDI), toluenediisocyanate (TDI) and hexamethylenediisocyanate (HDI).
9. A process for preparing a membrane, comprising the steps
   (i) providing a solution (L1) at least comprising a polyurethane (PU1);
   (ii) preparing a membrane from solution (L1) using phase inversion.
10. The process according to embodiment 9, wherein the solution (L1) comprises at least one additive selected from the group consisting of mono-, di- or trialkanols bearing no further functional groups like iso-propanol, ethylene glycol, propylene glycol or propylenetriol (glycerin).
11. The process according to embodiment 9 or 10, wherein step (ii) comprises the steps (ii-a) and (ii-b):
   (ii-a) forming a film from solution (L1);
   (ii-b) bringing the film in contact with a mixture (L2).
12. The process according to embodiment 11, wherein the mixture (L2) comprises water.
13. Use of a membrane according to any one of embodiments 1 to 8 or a membrane obtained or obtainable according to a process according to any one of embodiments 9 to 12 for coating a woven article.
14. Membrane, comprising a polyurethane (PU1), wherein the polyurethane (PU1) is based on the following components:
   80 to 100% by weight of a mixture of at least one diol (D1) and at least one polyisocyanate (I1), and
   0 to 20% by weight of at least one compound (C1) with at least two functional groups which are reactive towards isocyanate groups,
   wherein the membrane has pores with an average pore diameter in the range of from 0.001 μm to 0.8 μm, determined using Hg porosimetry according to DIN 66133.
15. The membrane according to embodiment 14, wherein the pore size distribution has a gradient over the diameter of the membrane.
16. The membrane according to embodiment 14 or 15, wherein the membrane comprises a further polyurethane (PU2) which is based on at least one polyol (P2), at least one diol (D2) and at least one polyisocyanate (I2).
17. The membrane according to any of embodiments 14 to 16, wherein the compound (C1) is a polyol.
18. The membrane according to any one of embodiments 14 to 17, wherein the compound (C1) is selected from the group of divalent residues of an oligo- or polysiloxane of the formula

-[Ak-O]_{q}-Ak-Si(R₂)—-[O—Si(R₂)]ₚ—O—Si(R₂)-Ak-[O-Ak]_{q′}- (I)
wherein Ak represents C₂-C₄ alkylene, R represents C₁-C₄ alkyl, and each of p, q and q′ independently is a number selected from the range 0-50.
19. The membrane according to any one of embodiments 14 to 18, wherein the membrane has a thickness in the range from 5 to 100 μm.
20. The membrane according to any one of embodiments 14 to 19, wherein the membrane has a liquid entry pressure in the range of 1 to 5 bar.
21. The membrane according to any one of embodiments 14 to 20, wherein the diol (D1) is selected from the group consisting of ethane diol, butane diol and hexane diol.
22. The membrane according to any one of embodiments 14 to 21, wherein the polyisocyanate is selected from the group consisting of diphenylmethanediisocyanate (MDI), toluenediisocyanate (TDI) and hexamethylenediisocyanate (HDI).
23. A process for preparing a membrane, comprising the steps
   (i) providing a solution (L1) at least comprising a polyurethane (PU1);
   (ii) preparing a membrane from solution (L1) using phase inversion.
24. The process according to embodiment 23, wherein the membrane has pores with an average pore diameter in the range of from 0.001 μm to 0.8 μm, determined using Hg porosimetry according to DIN 66133.
25. The process according to embodiment 23 or 24, wherein the pore size distribution has a gradient over the diameter of the membrane.
26. The process according to any of embodiments 23 to 25, wherein the solution (L1) comprises at least one additive selected from the group consisting of mono-, di- or trialkanols bearing no further functional groups like iso-propanol, ethylene glycol, propylene glycol or propylenetriol (glycerin).
27. The process according to any of embodiments 23 to 26, wherein step (ii) comprises the steps (ii-a) and (ii-b):
   (ii-a) forming a film from solution (L1);
   (ii-b) bringing the film in contact with a mixture (L2).
28. The process according to embodiment 27, wherein the mixture (L2) comprises water.
29. Use of a membrane according to any one of embodiments 14 to 22 or a membrane obtained or obtainable according to a process according to any one of embodiments 23 to 28 for coating a woven article.

### BRIEF DESCRIPTION OF THE FIGURES

FIG. 1 shows SEM pictures of the membrane obtained according to example 1 of the invention. FIG. 1(a) is a picture of the bottom surface, FIG. 1(b) is a SEM picture of the cross section of the membrane and FIG. 1(c) is a picture of the surface of the membrane. The pictures show that the membrane has a pore size gradient with small pores in the top layer (surface/skin) and bigger pores towards the bottom of membrane.

Examples will be used below to illustrate the invention. The examples which follow are for illustration of the invention, but are not in any way restricting as regards the subject matter of the present invention.

### EXAMPLES

### 1. Preparation of the Polyurethane (Hardphase)

### 1.1 Compounds Used

The following compounds were used:

| | | Molecular |
|---|---|---|
| Abbreviation | Compound | weight [g/mol] |
| Iso 1 | 4,4′Methylenediphenylendiisocyanate | 250.26 g/mol |
| Iso 2 | m-Tolylidenediisocyanate(T80) | 174.2 g/mol |
| Iso 3 | Hexamethylene-1,6-diisocyanate | 168.2 g/mol |
| KV 1 | 1,2-ethane diol | 62.07 g/mol |
| KV 2 | 1,4-butane diol | 90.12 g/mol |
| KV 3 | diethylenglykole (2,2′Oxi-diethanol) | 106.12 g/mol |
| KV 4 | 1,6-hexane diol | 118.2 g/mol |

### 1.2 Examples

### (a) Polyurethane (Hardphase) Type 1

In a 21 tin container, the chain extender (KV) was dispensed. Subsequently, the isocyanate Iso1 or Iso2 was added under gentle stirring and the reaction mixture was carefully heated to 70° C. with heated air. The mixture was stirred until a temperature of 90° C. was reached. Then, the reaction mixture was poured into a flat bowl and heated for 10 minutes at 125° C. on a heating plate. The slab obtained was tempered in a heating oven for 15 hours at 80° C.

### (b) Polyurethane (Hardphase) Type 2

In a 21 tin container, the chain extender (KV) was dispensed and heated to 80° C. Subsequently, the isocyanate Iso3 was added and the mixture was stirred at 220 rpm until a temperature of 110° C. was reached. Then, the reaction mixture was poured into a flat bowl and heated for 10 minutes at 125° C. on a heating plate. The slab obtained was tempered in a heating oven for 15 hours at 80° C.

The material obtained was cut into pieces and milled to a granulate.

### 1.3 Composition of the Materials Prepared

| | Isocyanate | Amount Iso | Diol | Amount KV | total amount | |
|---|---|---|---|---|---|---|
| Hardphase | (Iso) | [g] | (KV) | [g] | [g] | |
| 1 | Iso 1 | 480.8 | KV 1 | 119.2 | 600 | |
| 2 | Iso 1 | 441.1 | KV 2 | 158.9 | 600 | |
| 3 | Iso 1 | 421.3 | KV 3 | 178.7 | 600 | |
| 4 | Iso 1 | 407.5 | KV 4 | 192.5 | 600 | |
| 5 | Iso 2 | 737.3 | KV 1 | 262.7 | 1000 | g |
| 6 | Iso 2 | 197.72 | KV 2 | 102.29 | 2 × 300 | g |
| 7 | Iso 2 | 186.43 | KV 3 | 113.57 | 2 × 300 | g |
| 8 | Iso 2 | 178.73 | KV 4 | 121.27 | 2 × 300 | g |
| 9 | Iso 3 | 219.13 | KV 1 | 80.87 | 2 × 300 | g |
| 10 | Iso 3 | 195.34 | KV 2 | 104.67 | 2 × 300 | g |
| 11 | Iso 3 | 183.94 | KV 3 | 116.05 | 2 × 300 | g |
| 12 | Iso 3 | 176.12 | KV 4 | 123.81 | 2 × 300 | g |

### 2. Preparation of Membranes

### 2.1 Abbreviations and Compounds Used in the Examples

| | |
|---|---|
| NMP | N-Methylpyrrolidone |
| GLY | Glycerin |
| DMAc | Dimethylacetamide |
| LEP | liquid entry pressure |
| WDD | water vapour permeability |

### 2.2 Testing Methods

The liquid entry pressure (LEP) of the membranes was tested according DIN EN 20811 using a pressure cell with a diameter of 60 mm using ultrapure water (salt-free water, filtered by a Millipore UF-system) up to 4 bar (40 000 mm water column). The LEP is defined as pressure value when the liquid water starts to permeate the membrane. A high LEP allows the membrane to resist to a high liquid water column and is desired.

The water vapour permeability (WDD) was measured with a cup method at 38° C. and 90% relative humidity according to DIN 53122. For a given membrane thickness absolute WDD values are reported. High WDD values are desired and allow high flow rates of water vapour.

The pore size distribution was determined using Hg porosimetry. The measurements were conducted according to DIN 66133.

### 2.3 Examples: Preparation of Porous Membranes Using N-Methylpyrrolidone as Polymer Solvent

General Procedure

Into a three neck flask equipped with a magnetic stirrer there were added 71 ml of N-methylpyrrolidone 1, 10 g glycerin as second dope additive and 19 g of TPU hardphase. The mixture was heated under gentle stirring at 60° C. until a homogeneous clear viscous solution, usually referred to as dope solution was obtained. The solution was degassed overnight at room temperature. Clear and transparent polymer solutions were obtained.

After that the membrane solution was reheated at 60° C. for 2 hours and casted onto a glass plate with a casting knife (150 microns) at 60° C. using an Erichsen Coating machine operating at a speed of 5 mm/min. The membrane film was allowed to rest for 30 seconds before immersion in a water bath at 25° C. for 10 minutes. After the membrane had detached from the glass plate, the membrane was carefully transferred into a water bath for 12 h. After several washing steps with water the membrane was stored wet until characterization regarding liquid entry pressure (LEP) and water vapour permeability (WDD) started. Table 1 summarizes the membrane properties.

### 2.4 Comparative Examples: Preparation of Non-Porous Films Using N-Methylpyrrolidone as Polymer Solvent

General Procedure

Into a three neck flask equipped with a magnetic stirrer there were added 81 ml of N-methylpyrrolidone 1, and 19 g of TPU hardphase. The mixture was heated under gentle stirring at 60° C. until a homogeneous clear viscous solution, usually referred to as dope solution was obtained. The solution was degassed overnight at room temperature. Clear and transparent polymer solutions were obtained.

After that the membrane solution was reheated at 60° C. for 2 hours and casted onto a glass plate with a casting knife (150 microns) at 60° C. using an Erichsen Coating machine operating at a speed of 5 mm/min. The membrane film was allowed to rest for 30 seconds before immersion in a water bath at 25° C. for 10 minutes. After the membrane had detached from the glass plate, the membrane was carefully transferred into a water bath for 12 h. After several washing steps with water the membrane was stored wet until characterization regarding liquid entry pressure (LEP) and water vapour permeability (WDD) started. Table 1 summarizes the membrane properties.

TABLE 1
Compositions and properties of membranes prepared; thickness
in [μm], LEP in [bar], WDD in [g/m² * d].

| | TPU | Hardphase No. | Thickness | LEP | WDD |
|---|---|---|---|---|---|
| Example 1 | BUMDI | 2 | 50 | 4 | 1224 |
| Example 2 | HEXMDI | 4 | 50 | 4 | 950 |
| Comparative 1 | BuMDI | 2 | 30 | 4 | 158 |
| Comparative 2 | HEXMDI | 4 | 30 | 4 | 97 |

Porous membranes produced according to the invention show improved water vapour permeability characteristics (WDD) over membranes known from the art. At the same time porous TPU membranes produced according to the invention show comparable liquid entry pressure properties (LEP) compared to membranes known from the art.

### 3. Pore Size Distribution of the Membranes

The pore size distribution of the membrane obtained according to example 1 according to the invention was determined using Hg porosimetry according to DIN 66133.

The results of the Hg porosimetry are summarized in table 2.

TABLE 2
Tabular report Hg porosimetry

| Pore diameter (μm) | Incremental pore area (m²/g) |
|---|---|
| 0.500 | 0.024 |
| 0.100 | 18.938 |
| 0.050 | 28.181 |
| 0.010 | 7.337 |
| 0.004 | 2.576 |

The average pore diameter accounts for 0.14445 μm and the median pore diameter (area) at 2.4575 psi and 29.570 m²/g accounts 0.08706 μm.

The membrane obtained according to example 1 of the invention was also tested using scanning electron microscopy (SEM). Both surfaces (bottom and top) of the membrane as well as a cross section of the membrane were examined.

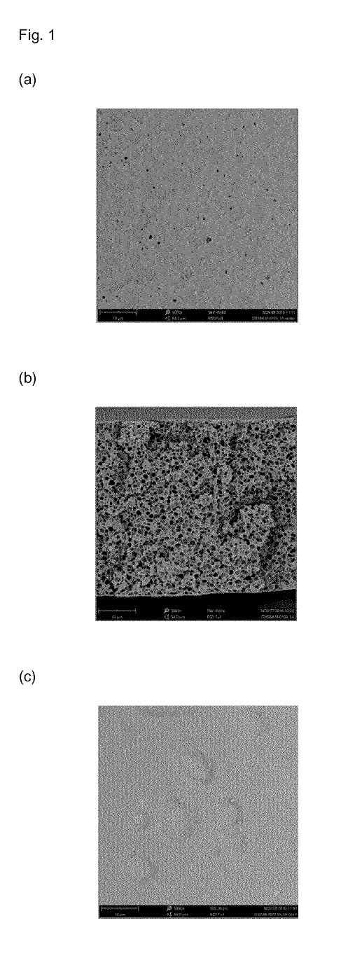

The measurements as shown in FIG. 1 show that the membrane has a pore size gradient with small pores in the top layer (skin) and bigger pores towards the bottom of membrane. FIG. 1(a) is a picture of the bottom surface, FIG. 1(b) is a SEM picture of the cross section of the membrane and FIG. 1(c) is a picture of the surface of the membrane.

1-16. (canceled)

17. A membrane, comprising a polyurethane (PU1), wherein the polyurethane (PU1) comprises:
80 to 100% by weight of a mixture of at least one diol (D1) and at least one polyisocyanate (I1), and
0 to 20% by weight of at least one compound (Cl) with at least two functional groups which are reactive towards isocyanate groups,
wherein the membrane has pores with an average pore diameter in the range of from 0.001 μm to 0.8 μm, determined using Hg porosimetry according to DIN 66133,
wherein the pore size distribution has a gradient over the diameter of the membrane.

18. The membrane according to claim 17, wherein the membrane comprises a further polyurethane (PU2) which is based on at least one polyol (P2), at least one diol (D2) and at least one polyisocyanate (I2)

19. The membrane according to claim 17, wherein the compound (C1) is a polyol.

20. The membrane according to claim 17, wherein the compound (C1) is selected from the group of divalent residues of an oligo- or polysiloxane of the formula
-[Ak-O]_{q}-Ak-Si(R₂)—[O—Si(R₂)]ₚ—O—Si(R₂)-Ak-[O-Ak]_{q′}- (1)
wherein Ak represents C₂-C₄ alkylene, R represents C₁-C₄ alkyl, and each of p, q and q′ independently is a number selected from the range 0-50.

21. The membrane according to claim 17, wherein the membrane has a thickness in the range from 5 to 100 μm.

22. The membrane according to claim 17, wherein the membrane has a liquid entry pressure in the range of 1 to 5 bar.

23. The membrane according to claim 17, wherein the diol (D1) is selected from the group consisting of ethane diol, butane diol and hexane diol.

24. The membrane according to claim 17, wherein the polyisocyanate is selected from the group consisting of diphenylmethanediisocyanate (MDI), toluenediisocyanate (TDI) and hexamethylenediisocyanate (HDI).

25. A process for preparing a membrane, comprising:
preparing a membrane from a solution (L1) at least comprising a polyurethane (PU1) using phase inversion,
wherein the membrane has pores with an average pore diameter in the range of from 0.001 μm to 0.8 μm, determined using Hg porosimetry according to DIN 66133, and
wherein the pore size distribution has a gradient over the diameter of the membrane.

26. The process according to claim 25, wherein the solution (L1) comprises at least one additive selected from the group consisting of mono-, di- or trialkanols bearing no further functional groups like iso-propanol, ethylene glycol, propylene glycol or propylenetriol (glycerin).

27. The process according to claim 25, wherein the preparing comprises:
forming a film from solution (L1); and
bringing the film in contact with a mixture (L2).

28. The process according to claim 27, wherein the mixture (L2) comprises water.

29. A process for coating a woven article, comprising coating the article with the membrane according to claim 17.
